(19) United States
(12) Patent Application Publication
(10) Pub. No.: US 2006/0293466 A1
(43) Pub. Date: Dec. 28, 2006

(54) Methods for synthesis of graft polymers

(75) Inventors: Mario Gauthier, Ontario (CA); Zhongshun Yuan, Ontario (CA)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: THE UNIVERSITY OF WATERLOO, Waterloo (CA)

(21) Appl. No.: 10/561,776

(22) PCT Filed: Jun. 21, 2004
(86) PCT No.: PCT/CA04/00924

§ 371 Date: Jun. 8, 2006

Related U.S. Application Data
(60) Provisional application No. 60/479,835, filed on Jun. 20, 2003.

(51) Int. Cl. C08F 8/08

(52) U.S. Cl. 525/387; 525/327.3; 525/331.9

(57) ABSTRACT

A process for the synthesis of arborescent polymers comprises epoxidation of a first polymer and grafting thereto a second polymer having groups reactive to the epoxide groups on the first polymer. The epoxidation and grafting steps can be repeated. In an additional embodiment, the present invention provides a one-pot method for the synthesis of arborescent polymers. In a reaction pot, a first polymer is copolymerized and then reacted with an activating compound in order to generate a polyfunctional macroinitiator. Monomers are then added to the reaction pot, the monomers having functional groups reactive towards reactive sites on the first polymer.

### BACKGROUND OF THE INVENTION

1. Field of the Invention

The present invention relates to methods for the synthesis of branched polymers. More specifically, the present invention provides methods for the synthesis of polymers having a dendritic architecture.

2. Description of the Prior Art

Synthetic polymers can take one of two general forms: linear or branched. Linear polymers are composed of a polymer backbone and pendent side groups inherent to the individual repeating units. Branched polymers have discrete units which emanate from the polymer either from the backbone or from the pendent groups extending from the individual repeating units. The branches have the same general chemical constitution as the polymer backbone. The simplest branched polymers, sometimes referred to as comb branched polymers, typically consist of a linear backbone which bears one or more essentially linear pendent side chains. Dendritic polymers are created by adding sub-branches to the branches extending from the main backbone. Dendritic polymers can be subdivided into 3 main categories: dendrimers, hyperbranched polymers and arborescent (or dendrigraft) polymers. Dendrimers are mainly obtained by strictly controlled branching reactions relying on a series of protection-coupling-deprotection reaction cycles involving low molecular weight monomers. Hyperbranched polymers are obtained from one-pot random branching reactions of polyfunctional monomers, resulting in a branched structure that is not as well defined as for dendrimers. Arborescent (or dendrigraft) polymers are obtained by successive grafting reactions of polymeric side chains on a polymer backbone.

Arborescent polymers are characterized by a tree-like or dendritic architecture incorporating multiple branching levels. These materials have a number of unique properties which make them potentially useful in a wide range of applications including controlled drug delivery vehicles, rheology modifiers for polymer processing, catalyst carriers, microencapsulation, and microelectronics (Esfand, R et al Drug Discovery Today 2001, 6, 427; Liu, M. et al Pharmaceutical Science and Technology Today 1999, 2, 393; Gitsov, I. et al Micropheres, Microcapsules & Liposomes 2002, 5, 31; PCT Patent Application WO 00/68298; Hong, Y. et al Polymer 2000, 41, 7705.)

Arborescent polymers are further characterized by the absence of cross-links among the branches. In contrast to dendrimers that use monomers as building blocks, arborescent polymers usually are assembled from linear polymer chains. The synthesis of arborescent polymers therefore requires fewer steps to achieve a high molecular weight, which makes them more practical from the point of view of applications.

The majority of arborescent polymers are currently synthesized from vinyl monomers by anionic polymerization and grafting (Teetstra, S. and Gauthier, M. Prog. Polym. Sci. 2004, 29, 277). In this approach, a linear polymer is first synthesized, functionalized with coupling sites, and reacted with living anionic polymer chains. Different types of functional groups such as chloromethyl, and acetyl functionalities can be introduced onto the benzene ring of polystyrene in order to obtain coupling substrates. A range of ‘living’ anionic polymers including polystyrene, poly(2-vinylpyridine), poly(tert-butyl methacrylate), and polyisoprene have been grafted onto polystyrene backbones to form arborescent homo- and copolymers. The synthesis of arborescent polymers by anionic polymerization and grafting, while more convenient than dendrimer syntheses, still requires multiple steps of substrate functionalization, polymerization, and grafting reactions. Furthermore, the coupling reaction is never complete, and linear polymer contaminant may need to be separated by fractionation before the synthesis of the next generation material.

Arborescent polymers are typically synthesized using cycles of substrate functionalization and anionic grafting reactions. Coupling sites are first introduced randomly on a linear substrate, and reacted with a ‘living’ polymer to yield a comb-branched or generation G0 arborescent polymer. Repetition of the functionalization and grafting cycles leads to upper generation (G1, G2 . . . ) arborescent polymers, with molecular weight and branching functionality increasing geometrically in successive generations if the branching density is maintained for successive generations. Both chloromethyl and acetyl functionalities have been used as coupling sites for the preparation of arborescent styrene homopolymers. Copolymers have also been obtained by grafting other macroanions onto arborescent polystyrene substrates.

Hempenius et al (Macromolecules 2001, 34, 8918) teach anionic grafting for the synthesis of arborescent butadiene homopolymers. Their method relies on the introduction of coupling sites by exhaustive hydrosilylation of pendent vinyl units on a polybutadiene substrate with dimethylchlorosilane, followed by coupling with polybutadienyllithium, Unfortunately the chlorosilane derivative obtained is hydrolytically unstable, and has to be generated immediately before use. Another problem is that the 1,2-butadiene unit content of the substrate obtained in the polymerization reaction determines the branching density of the graft polymers.

At present, no methodology for the synthesis of arborescent isoprene homopolyers 8 has been developed. Isoprene homopolymers have a wide range of physical properties and applications, and are rubbery in nature.

While the ‘grafting onto’ scheme, as described above, provides macromolecules with a narrow molecular weight distribution, it also depends on a large number of reaction steps.

In order to overcome the need for multi-step synthesis, attempts have been made to provide a one-pot methodology for synthesis of polymers displaying properties similar to dendrimers and aborescent polymers.

U.S. Pat. No. 6,255,424 discloses a one-pot synthesis based on simultaneous anionic copolymerization and grafting reactions of styrene with either p-chloromethylstyrene or p-chlorodimethylsilylstyrene. As such the anionic propagating center at the focal point of the growing polymer, and the vinyl coupling sites on the branched polymer molecules adding to the focal point, is always sterically hindered by surrounding side chains. This steric hindrance limits the growth of the molecules and, therefore, it is very difficult to obtain a very high molecular weight polymer with a high branching density under these conditions.

In another methodology, (Baskaran, D. Polymer 2003, 44, 2213) self-condensing anionic copolymerization of styrene with m-diisopropenybenzene is conducted in order to synthesize hyperbranched polystyrenes. The polymers obtained are characterized by multimodal molecular weight distributions. One-pot ATRP (atom transfer radical polymerization) copolymerization of styrene with p-chloromethylstyrene to generate side chains, combined with successive additions of ATRP catalyst was likewise investigated (Coskun, M. et al. J. Polym. Sci., Part A: Polym. Chem. 2003, 41, 668; Gaynor, S. G. et al. Macromolecules 1996, 29, 1079) to synthesize arborescent polystyrenes. This approach is limited by the occurrence of cross-linking, and the difficulty in separating ATRP catalysts from the final products. Cationic copolymerization of isobutene with p-methoxymethylstyrene, as sites used to generate side chains, in combination with successive additions of cationic catalysts, provided a one-pot method to synthesize arborescent polyisobutenes (Paulo, C. et al. Macromolecules 2001, 34, 734).

It is an object of the present invention to obviate or mitigate at least some of the above mentioned disadvantages.

### SUMMARY OF THE INVENTION

A method for producing an arborescent polymer comprising the steps of:
a. Epoxidizing a first polymer with an epoxidizing agent such that epoxide groups are chemically bonded to the first polymer at one or more sites; and,
b. grafting a second polymer onto the epoxidized first polymer such that chemical bonds are formed between the first and second polymers so that the bond is formed at the epoxide groups,
   wherein the second polymer includes reactive groups capable of forming bonds with the epoxide groups.

In an additional embodiment the present invention provides a one-pot method of synthesizing arborescent polymers. Such method of the present invention includes the following steps in a single reaction pot:
1. Copolymerization of a first polymer.
2. The first polymer is reacted with an activating compound to generate reactive sites on the first polymer in order to produce a polyfunctional macroinitiator.
3. Adding monomers having functional groups reactive towards the reactive sites on the first polymer, so that a bond is formed between the functional group and the reactive site.

When a mixture of monovinyl and divinyl monomers is used in step 3, the grafted polymer generated by the above reaction may be subjected to a further cycle of activation and addition of monomers in order to grow side chains from the initiating sites.

### BRIEF DESCRIPTION OF THE DRAWINGS

These and other features of the preferred embodiments of the invention will become more apparent in the following detailed description in which reference is made to the appended drawings wherein:

FIG. 1 depicts a reaction scheme for the synthesis of arborescent polyisoprene homopolymers.

FIG. 2 presents ¹H NMR spectra for the synthesis of sample G0: (a) linear polyisoprene substrate, (b) linear epoxidized polyisoprene substrate, and (c) fractionated graft polymer.

FIG. 3 depicts SEC elution curves for the synthesis of linear arborescent polyisoprenes of successive generations.

FIG. 4 depicts a preferred one-pot method reaction scheme.

FIG. 5 depicts the reactivity of unsaturated species and propagation centers.

FIG. 6 illustrates the influence of monomer addition rate and addition protocol on the molecular weight distribution of linear styrene-DIPB copolymers.

FIG. 7 further illustrates the influence of monomer addition rate and addition protocol on the molecular weight distribution of linear styrene-DIPB copolymers.

FIG. 8 illustrates the influence of polymerization time on the molecular weight distribution of G0 polymers.

FIG. 9 compares SEC traces obtained for the one-pot synthesis of a linear substrate (L5), G0 substrate (G0-5b), and G1 polystyrene (G1-5b)

### DESCRIPTION OF THE PREFERRED EMBODIMENTS

The term ‘living polymers’ as used herein refers to polymers that have partly ionized end groups (or have ionic character) with which additional monomer units may react.

The term ‘apparent polydispersity index’ (M_{w}/Mₙ) as defined herein is a measure of the uniformity of the population of polymers. M_{w}/Mₙ is calculated as the ratio of the apparent weight-average-average molecular weight (M_{w}) of the polymers over the apparent number-average molecular weight (Mₙ). The apparent M_{w}/Mₙ may be determined by size exclusion chromatography (SEC) analysis using a linear polystyrene standards calibration curve and a differential refractometer (DRI) detector.

The term ‘grafting onto’, as used herein, refers to a method of producing branched polymers in which functional groups on a first polymer are reacted with reactive sites on a second polymer, in order to chemically bond the second polymer onto the first polymer.

The term ‘grafting from’ as used herein refers to a method of producing reactive sites on a first polymer, followed by the addition of a monomer to the reactive sites in order to grow side chains from the reactive sites.

The term ‘one-pot reaction’, as used herein, refers to a method of producing arborescent polymers of successive generations by a sequence of reactions carried out sequentially in the same reactor (reaction pot), without isolation of products at any step.

Synthesis of Arborescent Polymers

In one embodiment, the present invention provides a method of generating arborescent homopolymers or copolymers comprising the following steps:
1. Epoxidation of a first polymer, such that epoxide functional groups are introduced onto the polymer.
2. A second polymer, having sites reactive towards epoxide groups, is reacted with the first polymer such that a bond is formed between the sites on the second polymer and the epoxide groups.
3. The grafted polymer generated by the above reaction may be subjected to several cycles of epoxidation and grafting in order to produce arborescent polymers of higher generations.

The first polymer is the core polymer to which other polymer molecules will be anionically grafted onto in the method of the present invention. Examples of a first polymer include, but are not limited to, polyisoprenes of different microstructures, polybutadienes of different microstructures, and other polydienes of different microstructures. The first polymer may be a homopolymer or a copolymer, and may be in linear, branched or dendritic form.

The first polymer may be generated by polymerization methods that are well known in the art. For example, the first polymer may be generated by anionic or cationic polymerization of unsaturated monomers. The first polymer may also be generated by other techniques known in the art for the generation of linear, branched or dendritic polymers. Following generation of the first polymer, it may be purified from non-reacted monomers and other excipients. The polymer may then be analyzed for uniformity of length and composition.

The first polymer is epoxidized to chemically bond epoxide groups along its length. Epoxidation of the first polymer is facilitated by the oxidation of alkene groups by peroxy compounds. In a preferred embodiment, in situ generated performic acid is used to generate the epoxidized first polymer of the present invention. An individual skilled in the art will recognize other peroxy compounds that can be used to epoxidize the first polymer.

The epoxidation of alkenes by peroxy compounds is an electrophilic reaction mainly controlled by the electron density of the double bond. Alkyl substituents increase the electron density of the double bond and hence its reactivity. The reaction order for substituted alkenes toward epoxidation therefore decreases in the order tetra->tri->di->mono->-unsubstituted.

The first polymer can be characterized by 1 to 50 mol % epoxidation. In a preferred embodiment, the first polymer is characterized by 20-30 mol % epoxidation, or 20-30% of the subunits in the polymer will bear an epoxide group. The degree to which the first polymer is epoxidized will be proportional to the number of branches that can be grafted onto the first polymer, within certain limitations. In reactions involving first polymers that are heavily epoxidized, not all the epoxide groups may be accessible to react due to steric hindrance. The degree of epoxidation of the first polymer may be controlled by varying the concentration of the epoxidizing agent that is being used, by varying the reaction times, or by methods that would be obvious to individuals of skill in the art.

The degree to which the first polymer is epoxidized may be determined by ¹H NMR spectroscopy, for example, by comparing the ¹H NMR spectrum of the epoxidized first polymer to that of the un-epoxidized first polymer. Other methods to determine the degree of epoxidation will be obvious to those of skill in the art.

The second polymer is the polymer that will be grafted onto the first polymer. The second polymer may be a homopolymer or copolymer, and may be linear, branched, or dendritic, although linear is preferred. The second polymer includes reactive groups which form chemical bonds with the epoxide groups of the first polymer. In a preferred embodiment, second polymers are living polymers having an anionic reactive group. In a preferred embodiment, the second polymer has a single reactive site. In a preferred embodiment, the reactive site is located at a terminal position on the second polymer. Examples of a second polymer include, but are not limited to, polyisoprene, polystyrene, and substituted polystyrenes.

The second polymer may be reacted with a capping agent Capping agents are molecules that chemically bind to the anionic terminal group and together with the terminal group, form the reactive site on the second polymer. Second polymers with capping agents are therefore less likely to undergo side reactions. Preferred capping agents are relatively small in order to avoid steric hindrance which may decrease the efficiency of the grafting reaction. An example of an appropriate capping agent is a capping agent derived from isoprene. Individuals of skill in the art will recognize other capping agents that may be used.

Generation of the G0 Polymer.

The G0 polymer is the product generated by one cycle of epoxidation of the first polymer and grafting of the second polymer. Typically, if the first polymer and the second polymer are linear, the G0 polymer will have a branched or comb structure. To generate the G0 polymer, the first polymer and the second polymer are combined in a suitable solvent under conditions that allow the reactive group on the second polymer to form a bond with epoxide groups on the first polymer.

The second polymer may undergo undesired side reactions wherein the anionic reactive group becomes neutralized

To decrease the incidence of side reactions, promoters may be used to promote the coupling reaction between the epoxidized first polymer and the second polymer. Three distinct approaches can be used to influence the course of the reaction. Firstly, a Lewis base, such as N,N,N′N′-tetramethylethylenediamine (TMEDA), may be added to complex with the lithium counterion and increase the nucleophilicity of the polyisoprenyl anions. Secondly, Lewis acids can serve to increase the reactivity of the epoxide ring via coordination. Finally, lithium salts decrease the reactivity of the polyisoprenyl anions by a common ion effect but also increase the reactivity of the epoxide ring via coordination.

Examples of such promoters include, but are not limited to: TMEDA, boron trifluoride, trimethylaluminum, LiCl, or LiBr.

Lithium salts, such as LiCl or LiBr, are most effective as promoters, increasing the grafting yield from 78% to 92% for a linear substrate. Lithium ions suppress the anionic charge of the second polymer. By decreasing the incidence of side reactions the second polymers maintain their anionic charge and are therefore available to react with the epoxide groups of the first polymer.

Although not essential, the progress of the reaction between the polymers, and the degree to which the polymers have reacted may be monitored. In one embodiment, samples are removed from the grafting reaction and are analyzed by size exclusion chromatography (SEC). Unreacted polymer will be detected as relatively low molecular weight species compared to the graft polymer. The results of such analysis may be used to monitor the progress of the reactions.

Under certain circumstances, not all the epoxide groups may be accessible for grafting due to steric hindrance. This may occur in particular if the first polymer is branched or dendritic and is heavily epoxidized. Also, in certain circumstances, G0 polymers may be generated in which only a fraction of the epoxide groups are reacted with the second polymer. For example, the remaining epoxide groups may be reacted with another molecular species. For these reactions, the amount of the second polymer to be added may also be calculated knowing the degree of epoxidation of the first polymer.

Upon completion of the grafting reaction, the branched G0 polymer may be purified and analyzed The form of the G0 polymer is determined by the structure of the first polymer and the second polymer.

The Generation of G1 and G2 Polymers

The G0 polymer may be used as a substrate for another cycle of epoxidation and grafting. For example, the G0 polymer may be epoxidized and a second polymer is reacted with the G0 polymer under similar grafting conditions as described previously. The reaction produces a G1 polymer wherein the branches have sub-branches. The degree of branching of the G1 polymer will be proportional to the degree to which the G0 polymer is epoxidized, within certain limitations described below. The second polymer may be added to the G0 polymer in a stoichometric amount In another embodiment, and excess of epoxide functionalities on the G0 polymer is used relative to the second polymer in order to maximize the grafting yield.

Repeating the epoxidizing/grafting cycle using the G1 molecule as a substrate will generate a more highly branched G2 molecule. The number of branches increases with each generation, epoxide groups that are on the core polymer or on branches near the core polymer may not be accessible to grafting due to steric hindrance. This may result in a decrease in the grafting efficiency or the number of second polymers that may react with a given number of epoxide groups. In reactions wherein the G0 and G1 polymers are generated with linear second polymers, reactions to generate further generations require 30-50% less second polymer compared to the number of epoxide sites on the polymer. As previously described, progress of the grafting reaction may be monitored by SEC.

In one embodiment, as described by example further below, linear polyisoprene is epoxidized and reacted with polyisoprenyllithium. More specifically, a linear polyisoprene substrate with a high (95%) 1,4-microstructure content is first epoxidized to introduce grafting sites randomly along the chain Although a linear polyisoprene with a high cis-1,4-microstructure content was used in this embodiment, an individual of skill in the art will recognize that polymers having other microstructures may be used. For example, a polymer having a mixed microstructure with equal proportions of 1,2-, 1,4-, and 1,3-units.

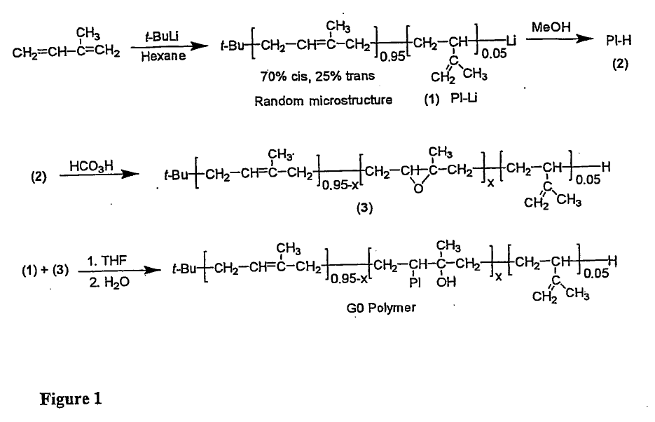

FIG. 1 depicts the coupling reaction utilized for an example of the method of the present invention, the preparation of arborescent polyisoprenes. A linear polyisoprene is first functionalized by partial epoxidation to introduce grafting sites randomly along the polymer chain. The epoxidized substrate, upon reaction with polyisoprenyllithium, yields a comb-branched (G0) isoprene homopolymer. As mentioned above, different promoters may be used to increase the rate and yield of the coupling reaction. The G0 polymer may be subjected to additional epoxidation and grafting cycles to generate upper generation arborescent polymers under the same conditions.

Further epoxidation and grafting of the G0 polyisoprene leads to arborescent isoprene homopolymers of generations G1 and G2. The graft polymers can be purified by fractionation and characterized by SEC, light scattering, and NMR spectroscopy.

One-Pot Synthesis of Arborescent Polymers

In an additional embodiment, the present invention provides a one-pot method of synthesizing arborescent polymers. In such method, a ‘grafting from’ scheme is utilized that allows the synthesis of consecutive generations of polymers from one single reaction pot. The one-pot approach of the present invention can be used to prepare homopolymers and copolymers.

Generally, the method of the present invention includes the following steps in a single reaction pot:
1. Copolymerization of a first polymer.
2. The first polymer is reacted with an activating compound to generate reactive sites on the first polymer in order to produce a polyfunctional macroinitiator.
3. Adding monomers having functional groups reactive towards the reactive sites on the first polymer, so that a bond is formed between the functional group and the reactive site.

When a mixture of monovinyl and divinyl monomers is used in step 3, the grafted polymer generated by the above reaction may be subjected to a further cycle of activation and addition of monomers in order to grow side chains from the initiating sites.

The first polymer is the core polymer to which monomers will be added in the ‘grafted from’ approach described further below. The first polymer is a linear, or mostly linear polymer having unsaturated sites which may be reacted with an activating compound in order to generate reactive initiating sites. Monomers may then be reacted with the reactive sites of the first polymer. The first polymer may also be branched, wherein linear polymers are attached to a linear core polymer, or dendritic wherein the polymers forming the branches have polymer branches attached to them.

The first polymer may be generated by polymerization of the appropriate monomers by methods known in the art, for example, anionic polymerization of alkene monomers. In a preferred embodiment, the first polymer is obtained by copolymerization of a monovinyl monomer and a divinyl monomer in order to produce a mostly linear molecule. The term “mostly” linear is used because, during copolymerization of the first polymer, side reactions may occur which produce “dimers”, wherein two chains of the polymer are linked together at random points along the chain. Following the generation of the first polymer, it may be purified from non-reacted monomers and other excipients.

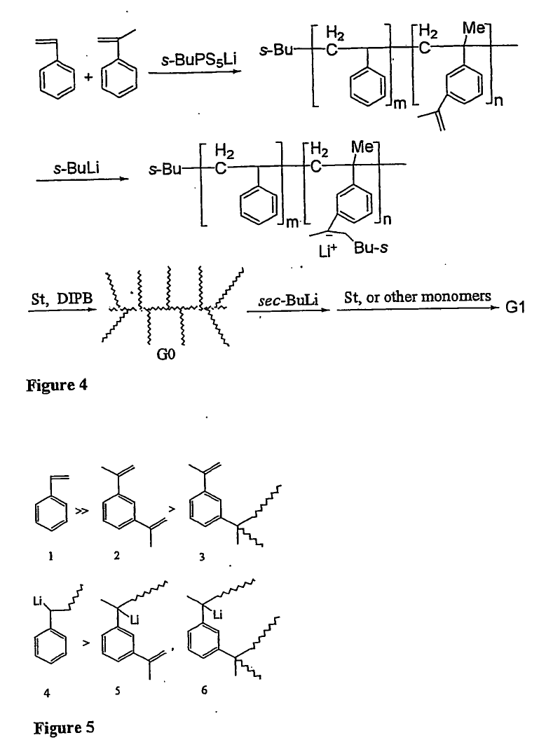

In a preferred embodiment, the first polymer is a linear copolymer, most preferably, the first polymer is a mostly linear styrene and 1,3-diisopropenylbenzene (DIPB) copolymer or a mostly linear sytrene and 1,4-diisopropenylbenzene copolymer. The synthesis of the styrene and 1,3-diisopropenylbenzene (DIPB) copolymer may be accomplished through methods that are known in the art A reaction scheme depicting the synthesis of the preferred first polymer is provided in FIG. 4. Due to the significant reactivity difference between styrene and DIPB, control over the monomer addition rate during synthesis of the copolymer may be needed to achieve a relatively random distribution of DIPB units in the styrene-DIPB copolymer, while preventing reaction of the second isopropenyl group.

After initiation, three types of propagating centers and three types of unsaturated species are present in the reaction depicted in FIG. 5. The reaction is therefore best described as a terpolymerization reaction. In FIG. 5, among the three propagating species, the double bonds in 2 and 3 have increased steric hindrance, and therefore a lower reactivity than 1. In compounds 2 and 3 the isopropenyl group is weakly electron-withdrawing, but converted to an alkyl functionality after polymerization, becoming electron-donating. Furthermore, because of increased steric hindrance from the polymer chain in the meta-position, compound 3 has a lower reactivity than 2. The lower reactivity of pendent isopropenyl groups was also pointed out in DIPB homopolymerization and its copolymerization with a-methylstyrene (Lutz, P. et al. Am. Chem. Soc. Div. Polym. Chem. Polym. Prepr. 1979, 20, 22). Similarly, since 5 and 6 have increased steric hindrance, their reactivity should be somewhat lower than 4. The reactivity difference can be confirmed from the color changes observed when adding the styrene-DIPB monomer mixture to the reactor. Styrene polymerizes first to give a yellow color initially. After styrene is consumed, DIPB polymerizes predominantly to give a dark brown color. Ideally monomers 1 and 2 should copolymerize randomly, to fall conversion, and without any reaction of species 3. If the conversion of DIPB is incomplete, both double bonds of the unreacted monomer are activated upon addition of sec-BuLi in the synthesis of next generation graft polymer, leading to the formation of linear polymer contaminant. The reaction of 3 leads to dimerization or cross-linking. To minimize the occurrence of these problems the reaction temperature, monomer ratio, concentration, monomer addition protocol, and reaction time (after monomer addition) need to be optimized.

In the method of the present invention, the first polymer is reacted in the reaction pot with an appropriate activating compound to generate reactive sites for the ‘grafting from’ of monomer units. The activating compound is a compound that can react with unsaturated sites on the first polymer, in order to generate a polyfunctional macroinitiator. An example of an activating compound that may be used in the process of the present invention is an organometallic compound including but not limited to, n-butyllithium or tert-butyllithium. In a preferred embodiment, the activating compound is sec-butyllithium.

In a preferred embodiment, the first polymer is dissolved in a solvent, such as cyclohexane or toluene, and is reacted with an organometallic compound. It will be evident to those skilled in the art that a number of solvents, reaction temperatures, and activating compounds may be used without departing from the scope of the invention.

FIG. 4 also depicts the activation of reactive sites on the preferred copolymer through reaction with sec-butyllithium.

In the one-pot method of the present invention, monomers are added to the reaction pot subsequent to the activation of reactive sites on the first polymer. The monomers react with the activated reactive sites of the first polymer and are chemically bonded to the first polymer. Monomers that may be utilized in the method of the present invention are anionically polymerizable monomers including, but not limited to, styrene, dienes, vinylpyridines, alkyl acrylates, alkyl methacrylates, ethylene oxide, hexamethylcyclotrisiloxane, and c-caprolactone. An individual of skill in the art will recognize other monomers which could be utilized in the present method. The addition of monomer units to an activated first polymer yields a polymer of generation G0. The G0 polymer may have, for example, a comb-branched structure. FIG. 4 illustrates the addition of styrene and DIPB monomers to the preferred styrene-DIPB copolymer in order to yield a G0 styrene-DIPB copolymer.

In the preferred embodiment, further reaction of the G0 styrene-DIPB copolymer with an activating compound generates a G0 polyfunctional anionic macroinitiator that can serve to produce G1 arborescent polymers with a dendritic structure. The G0 polymer reacts with the activating compound to produce reactive sites on the G0 polymer. Monomers are then added to the reaction pot subsequent to the activation of reactive sites on the G0 polymer. The monomers react with the activated reactive sites of the G0 polymer and are chemically bonded to the polymer.

The length (molecular weight) of the side chains generated during each ‘grafting from’ cycle can be controlled by varying the amount of monomer added to the macroinitiator at each step.

The cycle of activating of reactive sites by an activating compound and addition of monomer units may be repeated to generate molecules of higher generations. Cycling may continue until the polymer has achieved a desired size, however the efficiency of monomer addition will decrease due to steric hindrance. In a preferred embodiment, the cycling is stopped after formation of a G1 polymer due to an increasing probability of side reactions.

FIG. 4 illustrates the addition of monomers to a G0 styrene-DIPB copolymer in order to produce a G1 copolymer.

In one embodiment, the monomer polymerization may be terminated shortly after addition of monomer units in order to prevent cross-linking between chains. Another strategy that may be used to avoid cross-linking is to use an excess amount of organometallic compound in the activation reaction.

Because the active centers are always located at the chain ends of the last chains grown, it is possible to add sequentially different monomers of comparable or increasing reactivity to obtain arborescent molecules with block copolymer side chains, for example. Monomers in the sequence styrene/isoprene, 2-vinylpyridine, acrylates/methacrylates could thus be added to synthesize branched molecules with homopolymer or block copolymer side chains and a wide variety of physical properties. The synthesis of grafted G0 and G1 polystyrene-block-poly(2-vinylpyridine) copolymers was achieved to illustrate this concept, as described by example below.

The monomer ratio used in the copolymerization reaction determines the branching density of the graft polymers. For example, in a preferred embodiment wherein the first polymer is a styrene-DIPB copolymer, to obtain compact molecules, a significant mole fraction (e.g., 20-30%) of pendent isopropenyl groups should be present within the chains. The monomer ratio also influences the extent of side reactions leading to dimerization. In the preferred embodiment, a high styrene content in the mixture should increase the probability of pendent isopropenyl group attack and dimerization. Conversely, at low styrene/DIPB ratios it may take a longer time for DIPB to polymerize, also increasing the cross-linking probability. Analysis results by gas chromatography confirmed that for a styrene/DIPB ratio of 2.5, it took a longer time for DIPB to reach a high conversion. Another problem is that when the density of pendent isopropenyl groups is high a significant number of sites may not be activated, thus favoring cross-linking in the subsequent reaction step (e.g., after addition of pure styrene monomer) because of the high reactivity of the anions generated. A relatively narrow molecular weight distribution is obtained for a styrene/DIPB ratio between 2.5-3, presumably due to decreased cross-linking probability.

To decrease the incidence of side reactions, additives may be used to control the reaction between, for example, monomers and the first polymer, or monomers and the G0 polymer. LiCl and lithium alcoholates are widely used to modify the reactivity of anionic propagating centers when lithium is the counterion (Huyskensa, P. L., et al. J. Molecular Liquids, 1999, 78, 151). Lithium salts, for example, may be added, if desired, in the present method in order to increase the efficiency of reactions.

The one-pot method of the present invention can be used to synthesize copolymers combining hydrophobic and hydrophilic chain segments.

The association of anionic ‘living’ polymers in medium- to low-polarity solvents is known to lead to decreased chain end reactivity (Roovers, J. E. et al. Can. J. Chew 1968, 46, 2711). In a preferred embodiment, in which the first polymer is a styrene-DIPB copolymer, the use of solvents such as toluene or cyclohexane under ambient conditions may be beneficial by minimizing the attack of pendent isopropenyl moieties by the polystyryl anions. Another potential advantage of this approach is that unlike THF, these solvents are inert towards organolithium compounds and cannot cause chain end deactivation in the synthesis of the styrene-DIPB copolymers.

Although not essential, the polymers generated by the method of the present invention may be characterized using methods known in the art. For example, size exclusion chromatography (SEC) analysis may be used to determine the apparent molecular weight of graft polymer samples. In addition, absolute weight-average molecular weight (M_{w}) of the graft polymers may be determined from either batch-wise light scattering measurement in toluene or THF or on a SEC system coupled with a multi-angle laser light scattering (MALLS) detector in THF. Other methods of characterizing the polymers produced by the method of the present invention will be evident to an individual skilled in the art.

A) Synthesis Based on Epoxidation

### EXAMPLE #1

### Solvent and Reagent Purification

Hexane (BDH, mixture of isomers, HPLC Grade) was purified by refluxing with oligostyryllithium under nitrogen, and introduced directly from the still into the polymerization reactor through polytetrafluoroethylene (PTFE) tubing. Tetrahydrofuran (THF, Caledon, reagent grade) was refluxed and distilled from sodium-benzophenone ketyl under nitrogen. Isoprene (Aldrich, 99%) was first distilled from CaH₂, and further purified immediately before polymerization by addition of n-butyllithium (Aldrich, 2.0 M solution in hexane; 1 mL solution per 20 mL isoprene) and degassing with three freezing-evacuation-thawing cycles, before recondensation into an ampule with a PTFE stopcock. Monomer ampules were stored at −78° C. before use. Boron trifluoride diethyl etherate (Aldrich, redistilled) was distilled twice before use. N,N,N′,N′-tetramethylethylenediamine (TMEDA) was first distilled from CaH₂, and then from n-butyllithium The initiator t-butyllithium (t-BuLi, Aldrich, 1.7 M solution in pentane) was used as received; its exact concentration was determined to be 1.9 M by the method of Lipton et al (J. Organomet. Chem. 1980, 186, 155) 2,2′-Bipyridyl (Aldrich, 99+%) was dissolved in purified hexane to give a 0.01 M solution. Lithium chloride (Aldrich, 99.9%), lithium bromide (Aldrich, 99%), trimethylaluminum (Aldrich, 2.0 M solution in toluene), toluene (BDH, HPLC grade), hydrogen peroxide (BDH, 29-32%), and formic acid (BDH, 96%) were used as received from the suppliers.

### EXAMPLE #2

### Isoprene Polymerization

An isoprene monomer ampule (30.0 g, 0.441 mol), the hexane line from the purification still, and a rubber septum were mounted on a four-neck 500-mL round-bottomed flask with a magnetic siring bar. The flask was flamed under high vacuum and filled with purified nitrogen. Hexane (100 mL) was added to the flask followed by 0.5 mL 2,2′-bipyridyl solution and the solvent was titrated with t-BuLi to give a persistent light orange color. The initiator (3.2 mL, 6.0 mmol t-BuLi, for a calculated M, =5000) was injected in the reactor, and isoprene was added drop-wise from the ampule. The flask was maintained in a water bath at room temperature (23-25° C.) for 5 h, and the reaction was terminated with nitrogen-purged methanol. The crude product (29.5 g) was recovered by precipitation in 2-propanol and drying under vacuum for 24 h. The polymer, analyzed by SEC, had a polystyrene-equivalent (apparent) M_{w}=5800, an absolute M_{w}=5400 (M_{w}/Mₙ=1.06) as determined by SEC using a multi-angle laser light scattering (MAL) detector, and a microstructure with 70% cis-1,4-, 25% trans-1,4- and 5% 3,4-units as determined by ¹H NMR spectroscopy.

For the polymerization of isoprene in non-polar solvents, a predominantly cis-1,4-microstructure resembling natural rubber is obtained, while chain end isomerization in polar solvents (such as THF) leads to a mixed microstructure with approximately equal proportions of 1,4-, 1,2- and 3,4 microstructures. In non-polar (hydrocarbon) solvents, the cis-1,4-content increases when the initiator concentration is decreased or the monomer concentration is increased.

### EXAMPLE #3

### Epoxidation of Polyisoprene

The epoxidation of the linear polyisoprene substrate is provided as an example. Toluene (200 mL), polyisoprene (10.0 g, 0.147 equiv isoprene units) and formic acid (7.50 g, 0.156 mol) were combined in a 500-mL jacketed round-bottomed flask with a magnetic stirring bar. The flask was heated to 40° C. with a circulating water bath and the H₂O₂ solution (17.7 g, 0.163 mol) was added drop-wise with stirring over 20 min. The reaction was continued at 40° C. for 50 min. The organic phase was washed with water until the aqueous layer reached pH 7. The polymer (10.3 g) was precipitated in methanol and dried under vacuum for 24 h. The epoxidation level of the sample determined by ¹H NMR analysis was 26 mol %.

### EXAMPLE #4

### Grafting Reaction

The preparation of a G0 (comb-branched) polyisoprene using optimized reaction conditions is described as an example of graft polymer synthesis using the method of the present invention. The linear epoxidized polyisoprene substrate (1.90 g, 7.0 mequiv epoxide units) was purified with three azeotropic drying cycles Li, J. and Gauthier, M. Macromolecules 2001, 34, 8918; Gauthier, M. and Möller, M., Macromolecules 1991, 24, 4548) in an ampule using THF before redissolution in 100 mL dry THF. A four-neck 500-mL round-bottomed flask with a magnetic string bar was set up with an isoprene ampule (28.0 g, 0.412 mol), the epoxidized substrate ampule, the dry hexane inlet, and a septum. The isoprene was polymerized with 3.0 mL t-BuLi solution (5.6 mmol, for a target Mₙ=5000) in 50 mL hexane as described above. After 5 h a sample was removed and terminated with methanol, to determine the side chain molecular weight. The substrate solution was added to the flask and the grafting reaction was allowed to proceed for 60 h at room temperature. Sample aliquots were removed by syringe every 6 h and terminated with degassed methanol to monitor the progress of the reaction. Residual macroanions were terminated with degassed water, and the crude product (28.1 g) was recovered by precipitation in methanol and dried under vacuum. The crude graft polymer was purified by precipitation fractionation from hexane/2-propanol mixtures, to remove the linear polyisoprene contaminant. The fractionated G0 polymer was further epoxidized and grafted by the same procedures described to yield upper generation polymers.

G1 and G2 arborescent polyisoprenes were prepared using the same techniques described for the synthesis of the G0 polymer.

The experimental results obtained for the synthesis of G0-G2 arborescent polyisoprenes using the optimized reaction conditions with high cis-1,4-polyisoprene side chains are summarized in Table 1. A living end to epoxide ratio of 0.9 and 6 equiv LiBr were added to all reactions. Under these conditions, the grafting yields typically ranged from 91% for the G0 polymer (grafting onto a linear substrate) to 76% for the G2 product (grafting onto a G1 substrate).

Size exclusion chromatography served to determine apparent molecular weights and molecular weight distributions for the side chain and graft polymer samples. The instrument, operated at 25° C., consists of a Waters 510 HPLC pump, a 500 mm×10 mm Jordi DVB Mixed-Bed Linear column (molecular weight range 10²-10⁷), and a Waters 410 differential refractometer (DRI) detector. THF at a flow rate of 1 mL/min served as eluent and linear polystyrene standards were used to calibrate the instrument.

The absolute weight-average molecular weight of the graft polymers was determined in heptane at 25° C. from light scattering measurements using a Brookhaven BI-200 μM light scattering goniometer equipped with a Lexel 2-W argon ion laser operating at 514.5 nm. A series of 6-8 solutions with linear concentration increments were measured at angles ranging from 30-1450. The M_{w} was determined by Zimm extrapolation to zero concentration and angle. The refractive index increment (dn/dc) values used in the calculations were measured at 25° C. on a Brice-Phoenix differential refractometer equipped with a 510 nm band-pass interference filter.

¹H NMR spectra were acquired for the polyisoprene, epoxidized polyisoprene, and graft polyisoprene samples on a Bruker-300 instrument in CDCl₃.

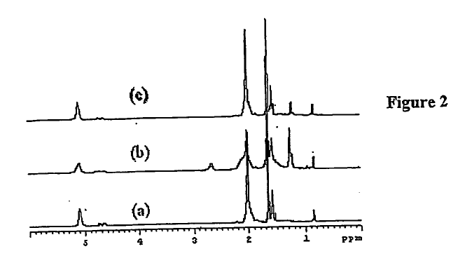

¹H NMR spectra for the purified G0 polymer (curve c), linear polyisoprene (curve a) and linear epoxidized polyisoprene (curve b) are compared in FIG. 2. The G0, G1, and G2 arborescent polyisoprenes have NMR spectra very similar to linear polyisoprene.

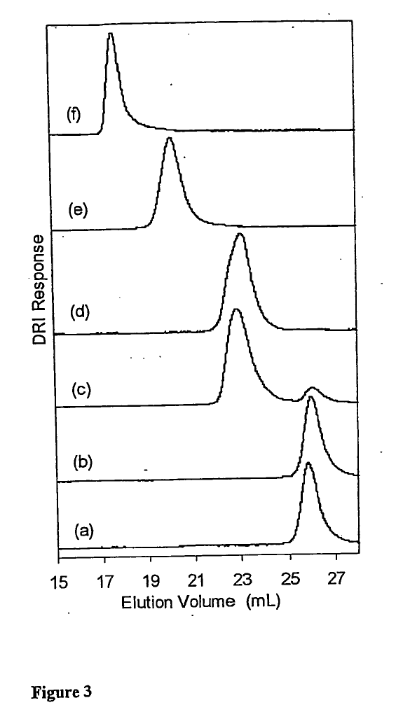

A series of SEC elution curves are provided in FIG. 3 for the synthesis of the G0 arborescent polyisoprene sample (curves a-d) and for the G1 and G2 purified graft polymers. Reaction of the polyisoprenyl anions (curve a) with the linear epoxidized polyisoprene substrate (curve b) yield a crude product (curve c) consisting of the coupling product (leftmost peak) and nongrafted polyisoprene side chains (rightmost peak). The grafting efficiency can be estimated from the SEC peak area. If the area of the graft polymer peak is defined as A1, and the area obtained for the non-grafted side chains A2, the grafting efficiency is approximated as A1/(A1+A2)×100%. The linear contaminant is easily removed from the crude product by fractionation (curve d), as well as from the G1 and G2 arborescent polymers (curves e-f). The apparent (polystyrene equivalent) M_{w} of the graft polymers, determined by SEC analysis using a differential refractometer (DRI) detector, ranges from 4.6×10⁴ (G0) to 8.8×10⁵ (G2), as indicated in Table 1. The absolute M_{w} of the same polymers, using light scattering, range from 8.7×10⁴ (G0) to 1.0×10⁷ (G2). The large (up to 10-fold) underestimation of M_{w} by SEC analysis with a DRI detector is clearly the result of the very compact structure of arborescent isoprene homopolymers, in analogy to former observations in various arborescent systems.

TABLE 1
Synthesis of higher generation graft polymers^{a}

| | Hexane:THF/ | M_{w}^{brb}/ | | | | M_{w}/10³ | | | |
|---|---|---|---|---|---|---|---|---|---|
| Gen | mL:mL | 10³ | Time/h | PDI | Yield/% | SEC^{c} | LS^{d} | f_{w}^{e} | ⁻Ce^{f}/% |
| G0 | 50:100 | 5.3 | 60 | 1.04 | 91 | 46 | 87 | 15 | 84 |
| G1 | 50:150 | 5.4 | 72 | 1.04 | 83 | 300 | 1100 | 180 | 54 |
| G2 | 50:200 | 5.5 | 75 | 1.05 | 76 | 880 | 10000 | 1630 | 44 |

^{a}All reactions using a side chain: epoxy group ratio = 0.9, LiBr: living end = 6, at 25° C.;
^{b}Absolute molecular weight of side chains;
^{c}Apparent molecular weight from SEC analysis using a differential refractometer detector and a linear polystyrene standards calibration curve;
^{d}Absolute molecular weight from light scattering;
^{e}Number of side chains added in the last grafting reaction;
^{f}Coupling efficiency.

The branching functionality of the graft polymers, also reported in Table 1, was calculated from the equation

$${f}_{w} = \frac{{M}_{w} ( G ) - {M}_{w} ( G - 1 )}{{M}_{w}^{br}} \qquad ( 1 )$$

where M_{w}(G), M_{w}(G−1), and M_{w}^{br} are the absolute molecular weights of polymers of generation G, of the previous generation, and of the side chains, respectively. It corresponds to the number of side chains added in the last grafting reaction.

The coupling efficiency (Cₑ), defined as the fraction (percentage) of epoxy coupling sites becoming linked to side chains, can be calculated as the ratio of f_{w} to the number of coupling sites on the substrate, or alternatively from the equivalent equation:

$${C}_{e} = \frac{{f}_{w} \cdot {M}_{M}}{{M}_{w} ( G - 1 ) \cdot E} \times 100 \qquad ( 2 )$$

where M_{M} is the molecular weight of isoprene (68.1), E is the epoxidation level of the substrate polymer, and Gₑ is grafting yield. The coupling efficiencies calculated based on the MALLS results are provided in Table 1. The decrease in coupling efficiencies observed from G0-G2 reflects the decreasing growth rates observed for higher molecular weight polymers.
B) One-Pot Synthesis of Arborescent Polymers

### EXAMPLE #5

### Solvent and Reagent Purification

Toluene (BDH, HPLC grade) was purified by refluxing with oligostyryllithium under nitrogen, and introduced directly from the still into the reaction flask through polytetrafluoroethylene (PTFE) tubing. Tetrahydrofuran (THF, Caledon, reagent grade) was refluxed and distilled from sodium-benzophenone ketyl under nitrogen. Styrene (Aldrich, 99%) was first distilled from CaH₂, and further purified immediately before polymerization by addition of phenylmagnesium chloride (Aldrich, 2.5 M solution in THF; 1 mL solution per 10 mL styrene) and degassing with three freezing-evacuation-thawing cycles before condensing into an ampule with a PTFE stopcock (Li, J. and Gauthier, M. Macromolecules, 2001, 34, 8918) under high vacuum. For the synthesis of arborescent polystyrene, and copolymers with 2-vinylpyridine and t-butyl methacrylate with different side chain length and identical branching functionalities by the successive monomer additions method, styrene was diluted (1.0 g in 10 mL solution) with THF by condensing THF under high vacuum to the ampule. 1,3-Diisopropenylbenzene (DIPB, Aldrich, 97%) was distilled twice from CaH₂. 1,4-Diisopropenylbenzene (1,4-DIPB) was synthesized by the Grignard reaction of dimethylterephthlate with MeMgI (Mitin, Y. V. Zhumal Obschei Khimii, 1958, 28,3303; Lutz, P. et al Eur. Polym. J. 1979, 15, 1111) and purified by two successive distillations from CaH₂. The DIPB and 1,4-DIPB monomers were finally purified by azeotropic drying with THF in an ampule before use, and purified styrene was added under nitrogen to obtain the required ratio in the monomer mixture. 2-Vinylpyridine (2VP, Aldrich, 97%) was first distilled from CaH₂, stirred again with CaH₂ overnight, and recondensed into an ampule under vacuum after degassing with three freezing-evacuation-thawing cycles. The monomer was then diluted with THF (10 mL/g) by recondensation under vacuum. t-Butyl methacrylate (BMA, TCI America, 98%) was first distilled under vacuum after stirring over CaH₂ overnight. It was further purified by degassing on a vacuum line, titration with a 1:1 mixture (v/v) of triethylaluminum (TEA, Aldrich, 1.9 M in toluene) and diisobutylaluminum hydride (DIBAH, Aldrich, 1.0 M in toluene) to a light greenish color, (Long, T. E. et al. In: Recent Advances in Mechanistic and Synthesis Aspects of Polymerization, M.; Guyot, A., Eds.; NATO ASI Ser. 1987, 215, 79; Allen, R. D. et al. Polym. Bull. 1986, 15,127) and recondensation into an ampule under vacuum after degassing with three freezing-evacuation-thawing cycles, before dilution with THF (10 mL/g). After purification, all monomer ampules were stored at −78° C. (dry ice) before use. N,N,N′,N′-tetramethylethylenediamine (TMEDA) was first distilled from CaH₂, and then from n-butyllithium. sec-Butyllithium (sec-BuLi, Aldrich, 1.3 M solution in cyclohexane) was used as received; its exact concentration was determined to be 1.35 M by the method of Lipton et al. (J. Organomet Chem. 1980, 186, 155). Lithium chloride (Aldrich, 99.9%) was flamed under high vacuum in an ampule and dissolved with purified THF (by vacuum condensation) before use.

### EXAMPLE #6

### Synthesis of Linear Styrene-DIPB Copolymer

A 1-L five-neck round-bottomed flask with a magnetic stirring bar was mounted on a high vacuum line together with toluene and THF inlets from the purification stills, a LiCl ampule (1.40 g in 50.0 mL. THF), and a rubber septum. The flask was flamed under high vacuum and filled with purified nitrogen. After cooling, toluene (20.0 mL) was added as well as 1 drop of styrene through a syringe. The solvent was titrated with sec-BuLi to give a persistent light yellow color. An aliquot of sec-BuLi (0.18 mL, 0.24 mmol) was then injected in the reactor, followed by 0.14 mL styrene (1.2 mmol, for a degree of polymerization DP=5). After 20 min, the flask was cooled to −78° C. and THF (40.0 mL) was added. After 10 min, 1.40 g (1.54 mL) of a styrene-DIPB mixture (3:1 ratio mol:mol, for an average DP=50) was injected from a gas-tight syringe (in 0.15 mL aliquots, followed by a 70-80 sec wait) over a period of 16 min, leading to color changes alternatively between yellow and brown. After addition of the monomer, the reaction was allowed to proceed at −78° C. with stirring for 1 h, while removing samples every 15 min for size exclusion chromatography (SEC) analysis. The reaction was then terminated by titration with a nitrogen-purged 10:1 THF-methanol mixture to just reach the (colorless) end point A 30-mL aliquot of the polymer solution was removed through the septum, and the concentration of residual DIPB was determined on a Hewlett-Packard 5890 gas chromatograph. The copolymer (0.72 g, 95% yield) was recovered by precipitation in methanol, dried under vacuum for 24 h, and analyzed by SEC (apparent Mₙ=7700, M_{w}/Mₙ=1.38 based on a linear polystyrene calibration curve) and ¹HNMR spectroscopy. Further results for the synthesis of linear styrene-DIPB copolymers are provided in Table 2.

TABLE 2
Synthesis of linear styrene-DIPB copolymers^{a}

| | | | Monomer | | | | |
|---|---|---|---|---|---|---|---|
| | | | addition | | | Polymer | |
| | | | | Time/ | Reaction time^{b}/ | Mₙ^{SEC}/ | |
| Sample | St:DIPB | Temp/° C. | Method | min | min | 10³ | M_{w}/Mₙ |
| L1 | 3:1 | −35 | Dropwise | 10 | 5 | 5.9 | 1.35 |
| | | | | | 30 | 6.4 | 1.46 |
| | | | | | 60 | 7.7 | 1.56 |
| L2 | 3:1 | −78 | Dropwise | 16 | 5 | 6.2 | 1.30 |
| | | | | | 30 | 6.9 | 1.34 |
| | | | | | 60 | 7.7 | 1.38 |
| L3 | 3:1 | −78 | Dropwise | 24 | 5 | 7.3 | 1.40 |
| | | | | | 30 | 7.5 | 1.43 |
| | | | | | 60 | 8.0 | 1.49 |
| | | | | | 120 | 9.3 | 1.69 |
| L4 | 3:1 | −78 | Syringe | 16 | 5 | 6.4 | 1.31 |
| | | | pump | | 30 | 6.9 | 1.38 |
| | | | | | 60 | 7.6 | 1.41 |
| L5 | 3:1 | −78 | Semi- | 13 | 5 | 6.8 | 1.27 |
| | | | batch | | 30 | 7.3 | 1.31 |
| | | | | | 60 | 7.5 | 1.32 |
| L6 | 2.5:1 | −78 | Dropwise | 16 | 5 | 6.1 | 1.41 |
| | | | | | 30 | 7.4 | 1.56 |
| | | | | | 60 | 7.8 | 1.62 |
| L7 | 2.5:1 | −78 | Semi- | 17 | 5 | 6.1 | 1.21 |
| | | | batch | | 30 | 7.4 | 1.32 |
| | | | | | 60 | 7.8 | 1.43 |
| L8 | 3.5:1 | −78 | Semi- | 12 | 5 | 6.3 | 1.35 |
| | | | batch | | 30 | 7.3 | 1.42 |

^{a}DP = 5 oligostyryllithium as initiator, 50 equiv mixed monomer added for chain growth;
^{b}Reaction time after monomer addition completed; L represents a linear copolymer, followed by a number representing the run (attempt) number.

As discussed further above, styrene and DIPB display a significant reactivity difference. If the monomer mixture is added too fast to the reaction, it will generate a tapered block copolymer with a styrene-rich first block and a DIPB-rich second block. This may cause two problems: First, DIPB would homopolymerize very slowly after styrene is consumed. Second, activation of the graft polymer obtained would be very difficult because part of the chain is very rich in DIPB. To synthesize a branched polymer with side chains more uniformly distributed along the backbone the monomer addition rate was decreased, to ensure significant monomer consumption before addition of the next monomer aliquot On the other hand, polystyryl anions may also attack the pendent isopropenyl groups more readily than the polyDIPB anions. If the monomer mixture is added too slowly a higher average concentration of polystyryl anions may be present in the reaction, thus increasing the probability of attack of the pendent isopropenyl groups and favoring dimerization or cross-linking. In other words, slow monomer addition may favor a high DIPB conversion but also broaden the MWD.

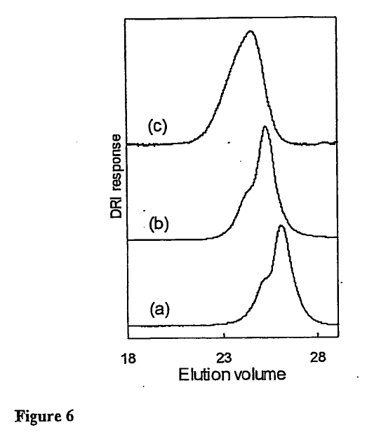

It can be seen by comparing the results in Table 2 obtained for samples L2-L3 that a longer monomer addition time leads to higher number-average molecular weight (Mₙ) and polydispersity index (M_{w}/Mₙ) values. The influence of monomer addition time on the MWD is also shown in the SEC traces of FIG. 6. Curves (b) and (c) were obtained for samples removed from the reactor 5 min after completing the monomer addition, for total monomer addition times of 16 min (sample L3) and 24 min (sample L2), respectively. It is clear that the peak molecular weight and the breadth of the MWD both increased for a fixed post-addition waiting time of 5 min. A larger amount of ‘dimer’ is formed in the reaction for longer monomer addition intervals, giving rise to a broader MWD. Because the rate of manual monomer addition may likely vary, a syringe pump was also used to add the monomer mixture at a more constant rate (sample L4). Comparison of the results obtained for samples L4 and L2 shows that the products are in fact comparable. Considering that both polystyryllithium and poly(1,3-diisopropenyl)lithium propagating centers are likely present at all times in the slow monomer addition protocol, and that polystyryllithium may attack pendent isoproprenyl moieties to cause dimerization, semi-batch monomer addition protocols were also investigated. In the semi-batch protocol a waiting time follows every mixed monomer addition, so that styrene polymerizes predominantly first and the residual monomer forms a short DIPB-rich segment at the chain ends. Under these conditions most polymer chains should be eventually capped with DIPB, thus decreasing the probability of pendent isopropenyl group attack. For samples L6 and L7 in Table 2 and curve (a) for L5 in FIG. 6, it can be seen that semi-batch addition leads to shorter monomer addition time (determined by color change) and a narrower MWD.

### EXAMPLE #7

### Synthesis of G0 (Comb-Branched) Styrene-DIPB Copolymer

The 30-mL reaction mixture remaining in the flask after the synthesis of the linear copolymer (0.76 g polymer) was diluted to 300 mL with purified THF and cooled to −20° C. using an ice-methanol bath. The mixture was titrated with sec-BuLi to a light brown color, and 1.35 mmol sec-BuLi (1.0 mL, for 23% metalation of the substrate based on the monomer mixture used, 92% metalation based on DIPB units alone) was added to produce initiating sites along the linear polymer substrate. After 4 h, the reaction mixture was cooled to −78° C., and 8.0 g styrene-DIPB (3:1 mol/mol) mixture (for a side chain DP=50 units) was added slowly over a period of 30 min producing color changes alternating between yellow and brown After addition of the monomer mixture the reaction was continued for 1 h, and samples were removed from the reactor after 5 min and 30 min for SEC and GC analysis. The reaction was terminated by titration with a 10:1 THF-methanol mixture. Two-thirds (200 mL) of the reaction mixture was then removed from the reactor. The polymer (5.7 g, 97% yield) was recovered by precipitation into methanol, dried under vacuum for 24 h and analyzed by SEC (apparent M_{w}=1.1×10⁵, M_{w}/Mₙ=1.78), NMR and SEC-MALLS (multi-angle laser light scattering).

Further results for the synthesis of G0 styrene-DIPB copolymers are provided in Table 3.

TABLE 3
Synthesis of G0 styrene-DIPB copolymers^{a}

| | | | Monomer | | | | | |
|---|---|---|---|---|---|---|---|---|
| | | | addition | | Waiting | G0 | | |
| | | | | Time/ | time | M_{w}/ | | Residual |
| Sample | St:DIPB | THF/mL | Method | min | (min) | 10³ | M_{w}/Mₙ | DIPB |
| G0-1 | 3:1 | 200 | Drop | 30 | 30 | 103 | 1.73 | ˜3% |
| | | | wise | | | | | |
| G0-2 | 3:1 | 200 | Drop | 40 | 30 | 116 | 1.83 | |
| | | | wise | | 60 | 129 | 1.94 | <1% |
| G0-4 | 3:1 | 200 | Syringe | 32 | 30 | 100 | 1.67 | |
| | | | pump | | 60 | 113 | 1.78 | <1% |
| G0-5a | 3:1 | 200 | Semi- | 34 | 30 | 86 | 1.66 | |
| | | | batch | | 60 | 98 | 1.77 | <1% |
| G0-5b | 3:1 | 300 | Semi- | 37 | 30 | 89 | 1.61 | |
| | | | batch | | 60 | 95 | 1.68 | <1% |
| G0-7a | 2.5:1 | 300 | Semi- | 37 | 30 | 91 | 1.66 | <1% |
| | | | batch | | 60 | 105 | 1.74 | |
| G0-7b | 2.5:1 | 300 | Semi- | 38 | 30 | 92 | 1.65 | |
| | | | batch | | 120 | 133 | 2.16 | Trace |
| G0-8 | 3.5:1 | 300 | Semi- | 30 | 30 | 85 | 1.68 | |
| | | | batch | | 60 | 99 | 1.78 | Trace |

^{a}Linear polymer metalated for 4 h at −20° C. with sec-BuLi, G0-1 polymerization at −35° C., other reactions at −78° C., 50 equiv styrene-DIPB monomer mixture used

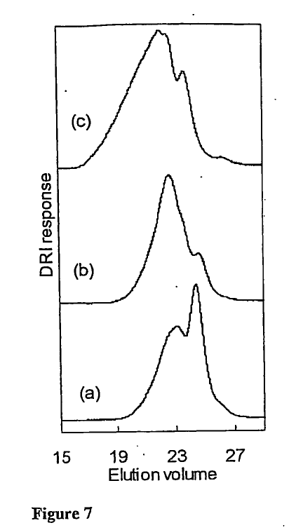

The SEC traces obtained for the synthesis of G0 copolymers by three different addition methods are compared in FIG. 7. The semi-batch addition protocol clearly produces a lower molecular weight and a narrower MWD for the G0 copolymer than the other protocols. This is seen in Table 3 for sample G0-5a (semi-batch addition), as compared to G0-2 (manual addition) and G0-4 (syringe pump addition).

### EXAMPLE #8

### Synthesis of G1 Styrene Arborescent Polymers

The G0 styrene-DIPB copolymer remaining in the flask (2.9 g polymer in 100 mL THF) was diluted with 400 mL THE, and 5.4 mmol sec-BuLi (4.0 mL, for 24% metalation based on the styrene and DIPB units in the side chains, 95% metalation based on DIPB units alone) were added at −20° C. After 4 h, the flask was cooled to −78° C., and LiCl (1.4 g in 50 ml THF, 6:1 ratio with respect to initiator) was added from an ampule, as well as 27.0 g styrene (for a calculated side chain Mₙ=5000) by syringe. After 2 min, the polymerization was terminated with degassed methanol. The polymer (29.3 g, 99% yield) was recovered by precipitation in methanol and fractionated with toluene as solvent and methanol as nonsolvent to remove linear polymer contaminant. The polymers were dried under vacuum for 24 h and analyzed by SEC, and ¹H NMR spectroscopy. The absolute M_{w} of samples was measured by light scattering.

The results obtained for the synthesis of G1 arborescent polystyrenes with a target side chain Mₙ=5000 and using a backbone metalation level of 94% based on isopropenyl units are presented in Table 4. Sample G1-1 formed a gel only 10 min after the addition of styrene. However there was no significant gel formation (2 mg/mL solution in THF easily filterable through a 0.45 μm filter) if the polymerization is terminated 2 min after styrene addition. Gel formation occurs as a result of cross-linking.

TABLE 4
Synthesis of G1 polystyrenes by sub-stoichiometric activation^{a}

| | | | G1 Polymer | | | Linear |
|---|---|---|---|---|---|---|
| | | Reaction | M_{w}^{GPC}/ | | | polymer |
| Sample | St:DIPB | time/min | 10⁵ | M_{w}^{LS}/10⁶ | M_{w}/Mₙ | (%)^{SEC} |
| G1-1 | 3:1 | 2 | 7.1 | | 1.20 | 31 |
| | | 10 | Gel | | | |
| G1-4 | 3:1 | 2 | 7.9 | | 1.19 | 9 |
| G1-5a | 3:1 | 2 | 7.6 | | 1.25 | 9 |
| G1-5b | 3:1 | 2 | 7.3 | 5.8 | 1.22 | 9 |
| G1-7a | 2.5:1 | 2 | 8.1 | | 1.23 | 10 |
| G1-7b | 2.5:1 | 2 | 10.6 | 15.7 | 1.24 | 4 |
| G1-8 | 3.5:1 | 2 | 7.3 | | 1.21 | 7 |

^{a}G0 polymer metalated for 4 h at −20° C. with 0.92 equiv sec-BuLi, target side chain Mₙ = 5000, polymerization at −78° C.

In Table 4 it can be seen that even though all the G0 substrates used in the reactions (Table 3) had a polydispersity index over 1.6, the G1 polymers obtained all had M_{w}/Mₙ≦1.25. As the side chain length increases, the MWD gradually becomes narrower. One possibility for this effect could be reactive site differentiation on the polyfunctional initiator substrates. Since polymers at the high molecular weight end of the MWD contain more initiating sites, intramolecular association may be unfavored for these molecules, making a fraction of the initiating sites less accessible, and thus self-regulating the growth of the molecules in the reaction mixture. A second reason could be that as the side chain length increases, the radius of gyration of all the polymers becomes comparable, thus producing a narrower range of SEC elution volume for the sample. A third possibility could be a separation artefact on the SEC column, due to decreasing separation efficiency of the columns in the high molecular weight range.

The amount of linear polymer generated in the reactions due to the presence of residual DIPB is provided in the last column of Table 4. Sample G1-1, synthesized from precursor G0-1, contained as much as 31% linear polymer contaminant. This is because the G0 precursor used was only allowed to react for 30 min after completion of the mixed monomer addition, and contained a significant amount of residual DIPB monomer. All the other G1 polystyrene samples, synthesized from G0 substrates 60 min after monomer mixture addition, contained less than 10% linear contaminant in the crude product Samples G1-7a and G1-7b were synthesized from the same linear polymer (L7), but from G0 substrates obtained after different reaction times. To this end, ½ of the reaction mixture was removed after 1 h and used to generate G1-7a. The remaining ½ of the reaction mixture in the flask was allowed to react 1 h longer and used to generate G1-7b. Clearly, a longer polymerization time for the G0 polymerizations yields less linear polymer. However since a longer waiting time in the synthesis of the G0 polymer also increases the probability of dimerization or cross-linking, a compromise must be drawn between producing less linear polymer and obtaining a narrower MWD. Because unreacted DIPB in the G0 polymer synthesis can be activated by sec-BuLi and generate linear polymer, one must find a compromise between a narrow MWD and less linear polymer generation.

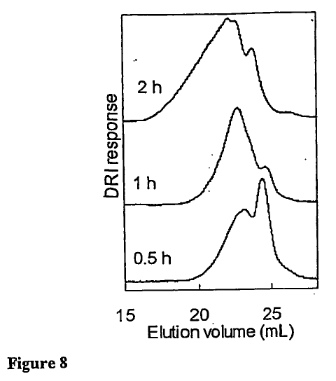

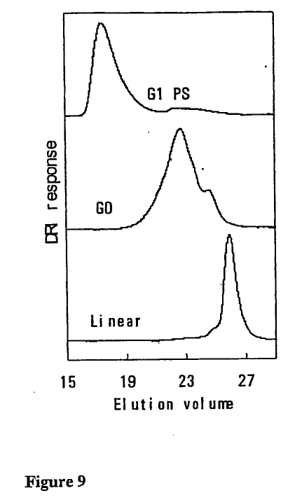

The influence of the waiting time in the G0 substrate synthesis on the amount of linear polymer obtained in the G1 polymer synthesis is illustrated in FIG. 8 with SEC curves obtained for polymerization times varying from 30 min to 2 h. The leftmost peak in the SEC traces is for the G1 arborescent polystyrene, and the rightmost bimodal peak corresponds to the linear polymer. While a 30 min wait in the G0 polymer synthesis produces a large amount of linear polymer, very little linear contaminant is obtained after 1 h. The linear polymer has a bimodal distribution because either one or both isopropenyl moieties of DIPB can be activated. A series of SEC elution curves is provided in FIG. 9 for linear, G0, and G1 polystyrene samples obtained using “optimal” reaction conditions corresponding to sample G1-5b.

### EXAMPLE #9

### One-Pot Synthesis of Analogous Arborescent Polymers with Different Side Chain Molecular Weights

The one-pot synthesis of G0 and G1 arborescent polystyrenes, arborescent polystyrene-graft-(polystyrene-block-P2VP) and arborescent polystyrene-graft-poly(tBMA) with different side chain molecular weights and the same branching functionality was achieved by activating the linear and G0 styrene-DIPB copolymers with an excess of sec-BuLi (110% initiator based on DIPB units) at −20° C., followed by several cycles of monomer addition (at −78° C. for styrene and 2VP, and at −20° C. for tBMA) and sample removal.

The synthesis of two series of analogous G0 and G1 arborescent polystyrenes is illustrated Table 5. In each series, the amount of monomer added at each step was adjusted to obtain side chains with a target Mₙ=2500, 5000, 10000 and 20000 based on the same substrate. To avoid cross-linking (gelation) during the extended reaction times required for the multiple monomer additions, a 10% excess sec-BuLi was used to ensure complete activation of the isopropenyl moieties on the styrene-DIPB copolymer substrates.

TABLE 5
Synthesis of analogous G0 and G1 polystyrenes^{a}

| | Target | M_{w}/10³ | | M_{w}/Mₙ | Linear |
|---|---|---|---|---|---|
| Substrate | Mₙ^{SC}/10³ | SEC | MALLS | (SEC) | Polymer/% |
| Linear | 2.5 | 140 | 95 | 1.50 | 2 |
| | 5.0 | 230 | 280 | 1.47 | 4 |
| | 10 | 710 | 770 | 1.39 | 8 |
| | 20 | 880 | 1500 | 1.26 | 10 |
| G0 | 2.5 | 600 | 2550 | 1.36 | 10 |
| | 5.0 | 640 | 5500 | 1.22 | 14 |
| | 10 | 660 | 9100 | 1.17 | 15 |
| | 20 | 890 | | 1.13 | 18 |

^{a}Substrate metalation level of 110% based on DIPB content; M_{w}(SEC) = 9100, M_{w}/Mₙ = 1.50 for linear substrate; M_{w} (SEC) = 125000, M_{w}/Mₙ = 1.69 for G0 substrate; 6 equiv LiCl added after metalation

A typical procedure for the synthesis of a series of arborescent G1 polystyrenes differing in side chain molecular weight is as follows. The 1-L five-neck reactor assembly and preparation methods used were generally the same as previously described, but included a styrene ampule (37.8 g in 380 mL THF) and a sampling tube. The synthesis of the G0 styrene-DIPB copolymer was conducted as described above. For the G1 copolymer synthesis, the G0 styrene-DIPB copolymer (1.50 g in 50 mL THF was diluted to 400 mL with THF. The reaction mixture was titrated with sec-BuLi to a light brown color, followed by 3.6 mmol sec-BuLi (2.7 mL, for 27.5% metalation based on the styrene and DIPB units in backbone, 110% metalation based on DIPB units alone). After 4 h activation at −20° C., the reaction mixture was cooled to −78° C., a solution of LiCl (1.20 g) in 50 mL THF was added to the reactor, followed by slow addition of 90 mL of the styrene-THF solution (for a target side chain Mₙ=2500). A quick color change from brown to yellow was observed. After 10 min polymerization at −78° C., an aliquot of polymer solution (185 mL; corresponding to 3.5 g polymer) was transferred through the sampling tube into a nitrogen purged graduated funnel where the polymer was terminated with degassed methanol. After a second monomer addition (6.0 g styrene in 60 ml THF, for a total side chain target Mₙ=5000) and 20 min waiting, 115 mL polymer solution (corresponding to 3.5 g polymer) was removed as above and terminated. A third aliquot of styrene solution (8.7 g in 87 ml THF, for a total side chain target Mₙ=10000) was added. After 30 min, 78 mL polymer solution (3.5 g polymer) was removed and terminated A fourth aliquot of styrene (14.2 g in 142 ml THF solution, for a total side chain target Mₙ=20000) was added. After 40 min, the polymerization was terminated by injecting degassed methanol into the reactor. All polymers were recovered by precipitation into methanol and characterized by SEC. The crude graft polymers were purified by precipitation fractionation using toluene as solvent and methanol as non-solvent, to remove linear polystyrene contaminant. The polymers were dried under vacuum for 24 h, and analyzed by MALLS to determine their absolute molecular weight. The G0 polystyrene sample series was synthesized by a similar procedure, using a linear styrene-DIPB copolymer substrate.

### EXAMPLE # 10

### Synthesis of Arborescent Polystyrene-graft-(Polystyrene-block-Poly(2-Vinylpyridine))Copolymer

A typical procedure for the synthesis of the arborescent G1 P2VP copolymers is as follows. The reactor assembly and preparation methods were generally the same as described above for the synthesis of arborescent polystyrenes with different side chain lengths, but included a 2VP ampule (32.9 g in 330 mL THF) in place of the styrene ampule. The synthesis of the G0 styrene-DIPB copolymer was conducted as described above. For the G1 copolymer synthesis, the G0 polymer solution in THF (1.1 g) was diluted to 400 mL with THF, and 2.5 mmol sec-BuLi (1.8 mL, for 27.5% metalation based on the styrene and m-DIPB units in the side chains, 110% metalation based on m-DIPB units alone) were added in the activation step. After 4 h metalation at −20° C., the reaction mixture was cooled to −78° C. and a LiCl solution (0.70 g in 50 ml THF) was added to the reactor, followed by 7.5 g styrene (for a calculated Mₙ=3000) through a gas tight syringe to obtain the G1 styrene homopolymer. After 10 min, a sample was removed for SEC characterization A 66 mL aliquot (6.6 g 2VP) of the 2VP solution (for a total side chain target M, =5500) was slowly added to the reactor. A quick color change from brown to red was observed After 10 min polymerization at −78° C., an aliquot of polymer solution (115 mL, corresponding to 3.5 g polymer) was transferred through the sampling tube into a nitrogen-purged graduated funnel where the polymer was terminated with degassed methanol. After a second monomer addition (6.0 g 2VP in 60 ml THF, for a total side chain target Mₙ=8000) and 20 min waiting, 90 mL polymer solution (corresponding to 3.5 g polymer) was removed as above and terminated. A third aliquot of 2VP solution (8.0 g in 80 ml THF, for a total side chain target Mₙ=13000) was added. After 30 min, 70 mL polymer solution (3.5 g polymer) was removed and terminated A fourth aliquot of 2VP (13.4 g in 134 ml THF solution, for a total side chain target Mₙ=23000) was added. After 40 min, the polymerization was terminated by injecting degassed methanol into the reactor. All polymers were recovered by precipitation into hexane and characterized by SEC analysis. The crude graft polymers were purified by precipitation fractionation using 4/1 THF/MeOH as solvent and hexane as non-solvent, to remove linear polystyrene-block-P2VP contaminant. The recovered polymer was dried under vacuum for 24 h, and analyzed by light scattering for absolute molecular weight and by NMR spectroscopy for composition. The G0 copolymers were synthesized using a similar procedure except for using the linear styrene-DIPB copolymer as substrate.

The results for the synthesis of aborescent G0 and G1 arborescent polystyrene-block-P2VP copolymers with Mₙ=3000 for the polystyrene block and Mₙ=2500, 5000, 10000, or 20000 for the P2VP block based on successive monomer additions are summarized in Table 6. The excess sec-BuLi used in the activation step led to the generation of a small amount of linear polystyrene-block-P2VP copolymer.

Comparing the SEC results of Table 6 with those obtained for the precursors, it is again clear that even though the linear and G0 substrates had relatively broad MWD, the G0 and G1 P2VP copolymers all had a narrower MWD. This is the same phenomenon observed in the synthesis of G0 and G1 polystyrene with different side chain lengths, and may have a similar origin. The last column in Table 6 gives the amount of new generation of linear polymers generated from residual DIPB and/or excess sec-BuLi. It can be seen that the linear polymer content varies from 12-34%, depending on the generation number of the substrate used and the molecular weight of the side chains. It may be possible to decrease the generation of linear polymer in these reactions by decreasing somewhat the excess of sec-BuLi used in the metalation step.

The absolute molecular weight of the copolymers was determined by SEC analysis using a MALLS detector for the G0 samples, and with batch-wise static light scattering measurements for the G1 copolymers. The apparent molecular weights measured by SEC analysis using a linear polystyrene standards calibration curve are much lower than those determined by light scattering, due to the compact structure of the branched polymers.

TABLE 6
Synthesis of analogous polystyrene-graft-(polystyrene-block-P2VP)
copolymers^{a}

| | Target | | | | | | |
|---|---|---|---|---|---|---|---|
| | Mₙ^{SC} | | | | | | Linear |
| | of | M_{w}/10³ | | M_{w}/Mₙ | P2VP/% | | Polymer/ |
| Substrate | P2VP/10³ | SEC | MALLS | (SEC) | Cal | NMR | % |
| Linear | 3.0 PS | 80 | 110 | 1.48 | 0 | | 12 |
| | 2.5 | 81 | 160 | 1.44 | 45 | 30 | 15 |
| | 5.0 | 130 | 220 | 1.38 | 63 | 56 | 18 |
| | 10 | 190 | 400 | 1.25 | 77 | 82 | 23 |
| | 20 | 280 | 1150 | 1.18 | 87 | 91 | 28 |
| G0 | 3.0 PS | 440 | 1400 | 1.67 | | | 23 |
| | 2.5 | 400 | 3100 | 1.31 | 45 | 43 | 26 |
| | 5.0 | 471 | 5400 | 1.25 | 63 | 66 | 29 |
| | 10 | 608 | 7300 | 1.24 | 77 | 87 | 32 |
| | 20 | 743 | 12200 | 1.21 | 87 | 95 | 34 |

^{a}Substrate metalation level of 110% based on DIPB content; M_{w} (SEC) = 9000, M_{w}/Mₙ = 1.48 for linear substrate; M_{w} (SEC) = 125000, M_{w}/Mₙ = 1.70 for G0 substrate; 6 equiv LiCl added after metalation

### EXAMPLE #11

### Synthesis of Arborescent Polystyrene-graft-Poly(t-Butyl Methacrylate) Copolymer

A typical procedure for the synthesis of arborescent G1 poly(tBMA) copolymers is as follows. The reactor assembly and preparation were generally the same as above described for the synthesis of arborescent polystyrenes with different side chain lengths, except that a tBMA ampule (38.2 g tBMA in 380 mL THF) was used in place of the styrene ampule. The synthesis of the G0 styrene-DIPB copolymer was conducted as described above. For the G1 copolymer synthesis, 1.50 g of the G0 styrene-DIPB copolymer in 50 mL THF was diluted with THF to 400 mL. The reaction mixture was titrated with sec-BuLi to a light brown color, before adding 3.6 mmol sec-BuLi (2.7 mL, for 27.5% metalation based on the styrene and DIPB units in backbone, 110% metalation based on DIPB units alone). After 4 h metalation at −20° C., a LiCl solution (1.20 g in 50 mL THF) was added to the reactor, followed by 90 mL tBMA-THF solution (for a target side chain Mₙ=2500). A quick color change from brown to faint green was observed. After 20 min polymerization at −20° C., an aliquot of polymer solution (185 mL, corresponding to 3.5 g polymer) was transferred through the sampling tube into a nitrogen-purged graduated funnel where the polymerization was terminated with degassed methanol. After a second monomer addition (6.0 g tBMA in 60 ml THF, for a total side chain target Mₙ=5000) and 30 min waiting, 115 mL polymer solution (corresponding to 3.5 g polymer) was removed as above and terminated. A third aliquot of tBMA solution (8.7 g in 87 ml THF, for a total side chain target Mₙ=10000) was added. After 40 min, 78 mL polymer solution (3.5 g polymer) was removed and terminated. A fourth aliquot of tBMA (14.2 g in 142 ml THF solution, for a total side chain target Mₙ=20000) was added. After 60 min, the polymerization was terminated by injecting degassed methanol in the reactor. All polymers were recovered by precipitation into a 4:1 methanol:water mixture and characterized by SEC analysis. The crude graft polymers were purified by precipitation fractionation using acetone as solvent and methanol as non-solvent, to remove linear poly(tBMA) contaminant. The recovered polymers were dried under vacuum for 24 h, and analyzed by MALLS for absolute molecular weight and NMR spectroscopy for composition. The G0 poly(tBMA) copolymer series was synthesized by a similar procedure except for using a linear styrene-DIPB copolymer as substrate.

Results for the synthesis of arborescent G0 and G1 PtBMA are summarized in Table 7. In analogy to the polystyrene and poly(2-vinylpyridine) systems, M_{w}/Mₙ decreases as the side chain length of the polymers increases. The linear polymer content of the crude products increased with increasing side chain molecular, suggesting that the linear polymer grew faster than the side chains of the branched polymer.

The absolute molecular weights from MALLS analysis are much higher than the apparent values, due to the compact structure of the branched polymers.

TABLE 7
Synthesis of analogous polystyrene-graft-PtBMA copolymers^{a}

| | Target | M_{w}/10³ | | | Linear |
|---|---|---|---|---|---|
| Substrate | Mₙ^{SC}/10³ | SEC | MALLS | M_{w}/M_{n (SEC)} | Polymer/% |
| Linear | 2.5 | 100 | 124 | 1.50 | 6.3 |
| | 5.0 | 210 | 230 | 1.41 | 9.2 |
| | 10 | 510 | 1000 | 1.23 | 12.8 |
| | 20 | 760 | 1500 | 1.16 | 14.0 |
| G0 | 2.5 | 420 | 490 | 1.43 | 8.7 |
| | 5.0 | 620 | 1120 | 1.25 | 13.7 |
| | 10 | 760 | 1820 | 1.23 | 21.4 |
| | 20 | 890 | 3350 | 1.18 | 27.8 |

All publications, patents and patent applications are herein incorporated by reference in their entirety to the same extent as if each individual publication, patent or patent application was specifically and individually indicated to be incorporated by reference in its entirety

Although the invention has been described with reference to certain specific embodiments, various modifications thereof will be apparent to those skilled in the art without departing from the spirit and scope of the invention as outlined in the claims appended hereto.

The embodiments of the invention in which an exclusive property or privilege is claimed are defined as follows:

1. A method for producing an arborescent polymer comprising the steps of:
a. Epoxidizing a first polymer with an epoxidizing agent such that epoxide groups are chemically bonded to the first polymer at one or more sites; and,
b. grafting a second polymer onto the epoxidized first polymer such that chemical bonds are formed between the first and second polymers so that the bond is formed at the epoxide groups,
wherein the second polymer includes reactive groups capable of forming bonds with the epoxide groups.

2. The method of claim 1 wherein the first polymer and the second polymer are either a homopolymer or a copolymer, and is either linear, branched or dendritic.

3. The method of claim 1 wherein the epoxidizing agent is a peroxy compound.

4. The method of claim 1 wherein the second polymer includes a single reactive group.

5. The method of claim 1 wherein the reactive groups are located at a terminal position on the second polymer.

6. The method of claim 1 wherein a cycle defined by steps a) and b) is repeated at least once, and wherein the polymer formed at b) of the preceding cycle is the substrate for the epoxidation reaction at a) in the subsequent cycle.

7. The method of claim 1 wherein the reaction between the first polymer and the second polymer, a promoter is utilized.

8. The method of claim 7 wherein the promoter prevents the neutralization of the anionic charge on the second polymer.

9. The method of claim 7 wherein the promoter is selected from the group consisting of a metal ion, a Lewis base, and a Lewis acid.

10. The method of claim 9 wherein the metal ion is a lithium ion.

11. The method of claim 10 wherein the metal ion is provided from a lithium salt.

12. The method of claim 11 wherein the lithium salt is selected from the group consisting of lithium chloride, and lithium bromide.

13. The method of claim 1 wherein the first polymer is selected from the group consisting of polyisoprene, and polybutadiene.

14. The method according to claim 1 wherein the second polymer is selected from the group consisting of polyisoprene, polystyrene, and substituted polystyrenes.

15. A one-pot method of synthesizing arborescent polymers, the method comprising the following steps in a single reaction pot:
1. Copolymerizing a first polymer,
2. Reacting the first polymer with an activating compound to generate reactive sites on the first polymer in order to produce a polyfunctional macroinitiator,
3. Adding monomers having functional groups reactive towards the reactive sites on the first polymer, so that a bond is formed between the functional group and the reactive site;
wherein when a mixture of monovinyl and divinyl monomers is used in step 3, a grafted polymer generated by the above reaction may be subjected to a further cycle of activation and addition of monomers in order to grow side chains from the initiating sites.
